(19) United States
(12) Patent Application Publication
(10) Pub. No.: US 2022/0383739 A1
(43) Pub. Date: Dec. 1, 2022

(54) Reward System For Collecting Feedback Based On Driving Records and Road Conditions and Method Thereof

(71) Applicants: Inventec (Pudong) Technology Corporation, Shanghai (CN); Inventec Corporation, Taipei City (TW)

(72) Inventors: Po-Hsiang Wu, Taipei City (TW); Chaucer Chiu, Taipei City (TW); Jiun-Kuej Jung, Taipei City (TW); Yu-Chang Chuang, Taipei City (TW)

(21) Appl. No.: 17/477,103

(22) Filed: Sep. 16, 2021

(30) Foreign Application Priority Data
May 31, 2021 (CN) 202110597577.5

(51) Int. Cl. G08G 1/04; G06K 9/32; G06K 9/00; G08G 1/01; G01C 21/00; G06Q 30/02; G06N 3/04

(52) U.S. Cl. CPC G08G 1/04; G06K 9/3258; G06K 9/00818; G08G 1/0112; G01C 21/3815; G01C 21/3833; G06Q 30/0226; G06N 3/04; G06K 2209/01

(57) ABSTRACT

A reward system and method collects feedback based on driving records and road conditions. A camera disposed on a vehicle can generate traffic-condition data, and the neural network based artificial intelligence is used to identify a traffic flow and a road-sign area in the traffic-condition data. When the road-sign area is identified, the optical character recognition is performed on the road-sign area to generate a geographic location information. The user information, the traffic flow and the geographic location information are embedded into the corresponding traffic-condition data. The traffic-condition data is transmitted to a map-data host for classification and storage. When the geographic location information of the traffic-condition data matches with road congestion location information and a clarity of the traffic-condition data is greater than a preset threshold, a contribution reward is calculated to improve timeliness of updating the traffic-condition data and the user's incentive for providing the traffic-condition data.

### CROSS-REFERENCE TO RELATED APPLICATION

This application claims the benefit of Chinese Application Serial No. 202110597577.5, filed May 31, 2021, which is hereby incorporated herein by reference in its entirety.

### BACKGROUND OF THE INVENTION

### 1. Field of the Invention

The present invention relates to a reward system and a method thereof, and more particularly to a reward system for collecting feedback based on driving records and road conditions and a method thereof.

### 2. Description of the Related Art

In recent years, with the popularity and vigorous development of the Internet of Things (IoT), various applications based on the IoT have sprung up. Among these applications, the Internet of Vehicles (IoV) is one of the applications of the IoT in the transportation field.

Generally speaking, conventional bicycles, cars, motorcycles or the like do not have the ability to connect to the network, so they are very limited in real-time data; for example, the update of map data for road navigation is taken as an example, it is difficult for a map-data host to obtain the real-time traffic-condition data, and it is also difficult for users (such as driver) to update the latest traffic-condition data in real time. On the other hand, in addition to the manufacturer's own investment in the update of traffic-condition data, the general user's willingness to provide real-time traffic-condition data is very limited, so there is a problem of insufficient real-time update of traffic-condition data and the user's poor incentive for providing traffic-condition data.

Therefore, some manufacturers have proposed the technical solution of using RN, and the technical solution enables drivers to stay connected to the map-data host through the network in real time and download the latest traffic-condition data from the map-data host. However, this technical solution only solves a part of the above-mentioned problem; that is, although the traffic-condition data can be downloaded from the map-data host, the traffic-condition data stored in the map-data host may be not the latest, so the user is still possible to obtain the outdated traffic-condition data. Obviously, the above-mentioned technical solution is still unable to effectively solve the problem of insufficient timeliness of the traffic-condition data and the user's poor incentive for providing the traffic-condition data.

According to the above-mentioned contents, what is needed is to develop an improved technical solution to solve the above-mentioned conventional technology problem of insufficient timeliness of the traffic-condition data and the user's poor incentive for providing the traffic-condition data.

### SUMMARY OF THE INVENTION

An objective of the present invention is to disclose a reward system for collecting feedback based on driving records and road conditions and a method thereof, so as to solve the above-mentioned conventional technology problem.

In order to achieve the objective, the present invention discloses a reward system for collecting feedback based on driving records and road conditions, the reward system includes at least one camera, an identifying module, a processing module and a map-data host. The at least one camera is disposed on a vehicle body, and when the at least one camera is enabled, the at least one camera continuously shoots to generate and transmit traffic-condition data. The identifying module is connected to the at least one camera and configured to receive the traffic-condition data from the at least one camera, and perform image identification on the received traffic-condition data to identify a traffic flow and a road-sign area in the traffic-condition data. When identifying that the road-sign area exists in the traffic-condition data, the identifying module performs an optical character recognition on the road-sign area to generate a geographic location information. The processing module is connected to the identifying module and configured to embed user information, the traffic flow and the geographic location information into the corresponding traffic-condition data, and transmit the embedded traffic-condition data. through network. The map-data host includes a storage module and a reward module. The storage module is configured to classify and store the traffic-condition data based on at least one of the user information and the geographic location information embedded in the traffic-condition data, when receiving the traffic-condition data. The reward module is connected to the storage module and configured to calculate a contribution reward corresponding to the user information when the geographic location information of the traffic-condition data matches with road congestion location information and a clarity of the traffic-condition data is greater than a preset threshold.

In order to achieve the objective, the present invention discloses a reward method for collecting feedback based on driving records and road conditions, and the reward method includes steps of: disposing at least one camera on the vehicle body, wherein when the camera is enabled, the camera continuously shoots to generate traffic-condition data; performing image identification on the traffic-condition data to identify a traffic flow and a road-sign area in the traffic-condition data, and when the road-sign area is identified in the traffic-condition data, performing an optical character recognition on the road-sign area to generate a geographic location information; embedding user information, the traffic flow and the geographic location information into the corresponding traffic-condition data, and transmitting the embedded traffic-condition data to a map-data host through network; when the map-data host receives the traffic-condition data, classifying and storing the traffic-condition data based on at least one of the user information and the geographic location information embedded in the traffic-condition data; and when the geographic location information of the traffic-condition data matches with road congestion location information and a clarity of the traffic-condition data is greater than a preset threshold, using the map-data host to calculate a contribution reward corresponding to the user information.

According to the above-mentioned system and method of the present invention, the difference between the present invention and the conventional technology is that, in the reward system of the present invention, the camera disposed on a vehicle body can generate traffic-condition data, and image identification is performed on the traffic flow and the road-sign area in the traffic-condition data, and when the road-sign area is identified, the optical character recognition is performed on the road-sign area to generate the geographic location information, and the user information, the traffic flow and the geographic location information are embedded into the corresponding traffic-condition data, and the embedded traffic-condition data is transmitted to the map-data host for classification and storage; when the geographic location information of the traffic-condition data matches with road congestion location information and the clarity of the traffic-condition data is greater than the preset threshold, the contribution reward corresponding to the user information is calculated.

The above-mentioned technical solution of the present invention is able to achieve the technical effect of improving timeliness of traffic-condition data update and the user's incentive for providing traffic-condition data.

### BRIEF DESCRIPTION OF THE DRAWINGS

The structure, operating principle and effects of the present invention will be described in detail by way of various embodiments which are illustrated in the accompanying drawings.

FIG. 1 is a system block diagram of a reward system for collecting feedback based on driving records and road conditions, according to the present invention.

FIGS. 2A and 2B are flowcharts of a reward method for collecting feedback based on driving records and road conditions, according to the present invention.

FIG. 3A is another system block diagram of a reward system ft collecting feedback based on driving records and road conditions, according to the present invention.

FIG. 3B is another system block diagram of a reward system for collecting feedback based on driving records and road conditions, according to the present invention.

FIG. 4 is a schematic diagram of shooting and transmitting traffic-condition data, according to application of the present invention.

### DETAILED DESCRIPTION OF THE PREFERRED EMBODIMENTS

The following embodiments of the present invention are herein described in detail with reference to the accompanying drawings. These drawings show specific examples of the embodiments of the present invention. These embodiments are provided so that this disclosure will be thorough and complete, and will fully convey the scope of the invention to those skilled in the art. It is to be acknowledged that these embodiments are exemplary implementations and are not to be construed as limiting the scope of the present invention in any way. Further modifications to the disclosed embodiments, as well as other embodiments, are also included within the scope of the appended claims.

These embodiments are provided so that this disclosure is thorough and complete, and fully conveys the inventive concept to those skilled in the art. Regarding the drawings, the relative proportions and ratios of elements in the drawings may be exaggerated or diminished in size for the sake of clarity and convenience. Such arbitrary proportions are only illustrative and not limiting in any way. The same reference numbers are used in the drawings and description to refer to the same or like parts. As used herein, the singular forms “a”, “an” and “the” are intended to include the plural forms as well, unless the context clearly indicates otherwise.

It is to be acknowledged that, although the terms ‘first’, ‘second’, ‘third’, and so on, may be used herein to describe various elements, these elements should not be limited by these terms. These terms are used only for the purpose of distinguishing one component from another component. Thus, a first element discussed herein could be termed a second element without altering the description of the present disclosure. As used herein, the term “or” includes any and all combinations of one or more of the associated listed items.

It will be acknowledged that when an element or layer is referred to as being “on,” “connected to” or “coupled to” another element or layer, it can be directly on, connected or coupled to the other element or layer, or intervening elements or layers may be present. In contrast, when an element is referred to as being “directly on,” “directly connected to” or “directly coupled to” another element or layer, there are no intervening elements or layers present.

In addition, unless explicitly described to the contrary, the words “comprise” and “include”, and variations such as “comprises”, “comprising”, “includes”, or “including”, will be acknowledged to imply the inclusion of stated elements but not the exclusion of any other elements.

The terms defined in the present invention are explained before description of the reward system for collecting feedback based on driving records and road conditions and a method thereof. In the present invention, the term “traffic-condition data” of the present invention means the traffic condition image or video shot by the camera.

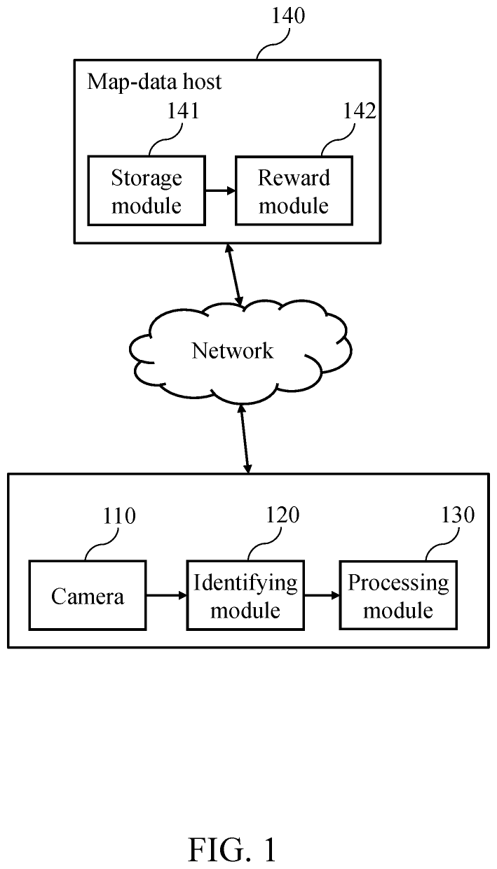

A reward system for collecting feedback based on driving records and road conditions and a method thereof of the present invention will hereinafter be described in more detail with reference to the accompanying drawings. Please refer to FIG. 1, which is a system block diagram of a reward system for collecting feedback based on driving records and road conditions, according to the present invention. The reward system includes a camera 110, an identifying module 120, a processing module 130, and a map-data host 140. The camera 110 is disposed on a vehicle body, and when the camera 110 is enabled, the camera 110 continuously generates and transmits traffic-condition data. In actual implementation, the camera 110 can transmit the traffic-condition data through a wired transmission manner or a wireless transmission manner. For example, the wired transmission can be implemented by copper conductive line, coaxial cable, or dual twisted wire; the wireless transmission manner can be implemented by Wi-Fi ZigBee, Constrained Application Protocol (CoAP), message queuing telemetry transport (MQTT) or other similar wireless transmission technology. In an embodiment, the camera 110 can include at least one of the charge-coupled device (CCD) and complementary metal-oxide-semiconductor (CMOS) for taking video or picture.

The identifying module 120 is connected to the camera 110, configured to receive the traffic-condition data from the camera 110, and perform the image identification on the received traffic-condition data, so as to identify a traffic flow and a road-sign area in the traffic-condition data. When the road-sign area is identified in the traffic-condition data, the identifying module 120 performs optical character recognition (OCR) on the road-sign area to generate the geographic location information. In actual implementation, the neural network based artificial intelligence can be used to perform the identification of the traffic flow and the road-sign area, for example, the artificial intelligence based image identification can be performed to identify vehicles in the traffic-condition data, and the amount of the identified vehicle can be calculated as the traffic flow; furthermore, in order to identify the road-sign area, the rectangular blocks showing white characters on a blue background, a green background and a brown background can be identified as the road-sign area; however, the present invention is not limited to these examples, and the identification process can be adjusted in accordance with the regulations of road traffic signs in various countries.

The processing module 130 is connected to the identifying module 120 and configured to embed user information, the traffic flow and the geographic location information into the corresponding traffic-condition data, and then transmit the embedded traffic-condition data through the network. For example, the user information can be “A1001”, the traffic flow can be a value of 5, and the geographic location information can be “section 3 of Bade road”. The processing module 130 embeds the information into the traffic-condition data, for example, the information can be added at the end, header or assigned field of an image/video file.

The map-data host 140 includes a storage module 141 and a reward module 142. When receiving the traffic-condition data, the storage module classifies and stores the traffic-condition data based on at least one of the user information and the geographic location information embedded in the traffic-condition data.. In actual implementation, the map-data host 140 can receive a usage area range (such as Bade road) set by the user; and compare the usage area range with the geographic location information of the traffic-condition data stored in the storage module 141, and then load the traffic-condition data matching with the usage area range, for example, the geographic location information is traffic-condition data of the Bade road; the map-data host 140 can display the traffic-condition data loaded from the storage module 141 and map information corresponding to the usage area range for example, the map information of Bade road. In practical application, the storage module 141 can be implemented by software, hardware or a combination thereof, such as database, files, hard drives, memory, disks, magnetic tape machine. Furthermore, when the traffic-condition data includes a shooting time, the map-data host 140 can classify and store the traffic-condition data based on the shooting time, and adjust an order of loading and displaying the traffic-condition data based on a difference between the shooting time and current time, for example, the traffic-condition data with a smaller difference is loaded and displayed in higher priority.

The reward module 142 is connected to the storage module 141. When the geographic location information of the traffic-condition data matches with road congestion location information and a clarity of the traffic-condition data is greater than a preset threshold, the reward module 142 calculates a contribution reward corresponding to the user information in actual implementation, the map-data host 140 can adjust the contribution reward corresponding to the user information based on at least one of a size of the traffic flow, repeat times of the geographic location information, and the times of loading the traffic-condition data. For example, in a condition that the traffic-condition data transmitted from a user A shows a higher traffic flow, it indicates that the traffic-condition data has higher importance, so the contribution reward for the user A is increased; in contrast, when the traffic-condition data has lower importance, the contribution reward for the user A is decreased. In a condition that the repeat times of the geographic location information, which corresponds to the traffic-condition data transmitted from the user A, is higher, it indicates that other user has transmitted the traffic-condition data already, so the contribution reward for the user A transmitting this traffic-condition data is decreased; in contrast, the contribution reward is increased. In a condition that the loading times of the traffic-condition data is higher, it indicates that more people require this traffic-condition data, the contribution reward is increased; in contrast, the contribution reward is decreased. The above-mentioned increasing and decreasing operations are taken as examples, when the original single contribution reward is 100%, and the increasing operation is to adjust the single contribution reward up to 200%, and the decreasing operation is to adjust the single contribution reward down to 50%. Furthermore, the map-data host 140 can be permitted to receive road congestion location information from the network, and permitted to input the traffic-condition data into a road congestion recognition model which is built based on a neural network and trained completely, and when the road congestion recognition model recognizes the traffic-condition data as a road congestion, the geographic location information of the traffic-condition data is used as the road congestion location information. In an embodiment, the road congestion recognition model can be a machine learning model which is trained completely, and the machine learning model can be built by deep learning technology, such as deep neural network (DNN), convolution neural network (CNN), recursive neural network (RNN) or sequential approximation neural network. Furthermore, after the map-data. host 140 calculates the contribution reward corresponding to the user information, the permission of using the hardware resource of the map-data host 140 can be adjusted based on the contribution reward; the hardware resource includes storage space, network bandwidth and memory. For example, the higher contribution reward means permission to use more hardware resources; in contrast, the lower contribution reward means permission to use fewer hardware resources. It is particularly noted that the contribution reward can be implemented by usage of more hardware resources, usage points, or bonus, and the rewards can be used to purchase, rent, or discount a product or service, so as to improve the user's incentives for providing the traffic-condition data.

It is to further explain that the camera, the identifying module and the processing module can be disposed in a mobile device; or the identifying module and the processing module can be disposed in the mobile device, and the mobile device is permitted to interconnect with the camera and the map-data host to transmit the traffic-condition data through the network; or the identifying module and the processing module can be disposed in the map-data host 140. In other words, the mobile device having camera and network transmission functions can interconnect with the map-data host with mobile application through a high speed network, for example, through 5th generation mobile networks (5G); or an additional camera is used to interconnect mobile application of the mobile phone and then interconnect to the map-data host in high speed, so as to implement the device design in consideration of low cost.

It is to be particularly noted that, in actual implementation, the modules of the present invention can be implemented by various manners, including software, hardware or any combination thereof, for example, in an embodiment, the module can be implemented by software and hardware, or one of software and hardware. Furthermore, the present invention can be implemented fully or partly based on hardware, for example, one or more module of the system can be implemented by integrated circuit chip, system on chip (SOC), a complex programmable logic device (CPLD), or a field programmable gate array (FPGA). The concept of the present invention can be implemented by a system, a method and/or a computer program. The computer program can include computer-readable storage medium which records computer readable program instructions, and the processor can execute the computer readable program instructions to implement concepts of the present invention. The computer-readable storage medium can be a tangible apparatus for holding and storing the instructions executable of an instruction executing apparatus Computer-readable storage medium can he, but not limited to electronic storage apparatus, magnetic storage apparatus, optical storage apparatus, electromagnetic storage apparatus, semiconductor storage apparatus, or any appropriate combination thereof. More particularly, the computer-readable storage medium can include a hard disk, an RAM memory, a read-only-memory, a flash memory, an optical disk, a floppy disc or any appropriate combination thereof, but this exemplary list is not an exhaustive list. The computer-readable storage medium is not interpreted as the instantaneous signal such a radio wave or other freely propagating electromagnetic wave, or electromagnetic wave propagated through waveguide, or other transmission medium (such as optical signal transmitted through fiber cable), or electric signal transmitted through electric wire. Furthermore, the computer readable program instruction can be downloaded from the computer-readable storage medium to each calculating/processing apparatus, or downloaded through network, such as internet network, local area network, wide area network and/or wireless network, to external computer equipment or external storage apparatus. The network includes copper transmission cable, fiber transmission, wireless transmission, router, firewall, switch, huh and/or gateway. The network card or network interface of each calculating/processing apparatus can receive the computer readable program instructions from network, and forward the computer readable program instruction to store in computer-readable storage medium of each calculating/processing apparatus. The computer program instructions for executing the operation of the present invention can include source code or object code programmed by assembly language instructions, instruction-set-structure instructions, machine instructions, machine-related instructions, micro instructions, firmware instructions or any combination of one or more programming language. The programming language include object oriented programming language, such as Common Lisp, Python, C++, Objective-C, Smalltalk, Delphi, Java, Swift, C#, Perl, Ruby, and PHP, or regular procedural programming language such as C language or similar programming language. The computer readable program instruction can be fully or partially executed in a computer, or executed as independent software, or partially executed in the client-end computer and partially executed in a remote computer, or fully executed in a remote computer or a server.

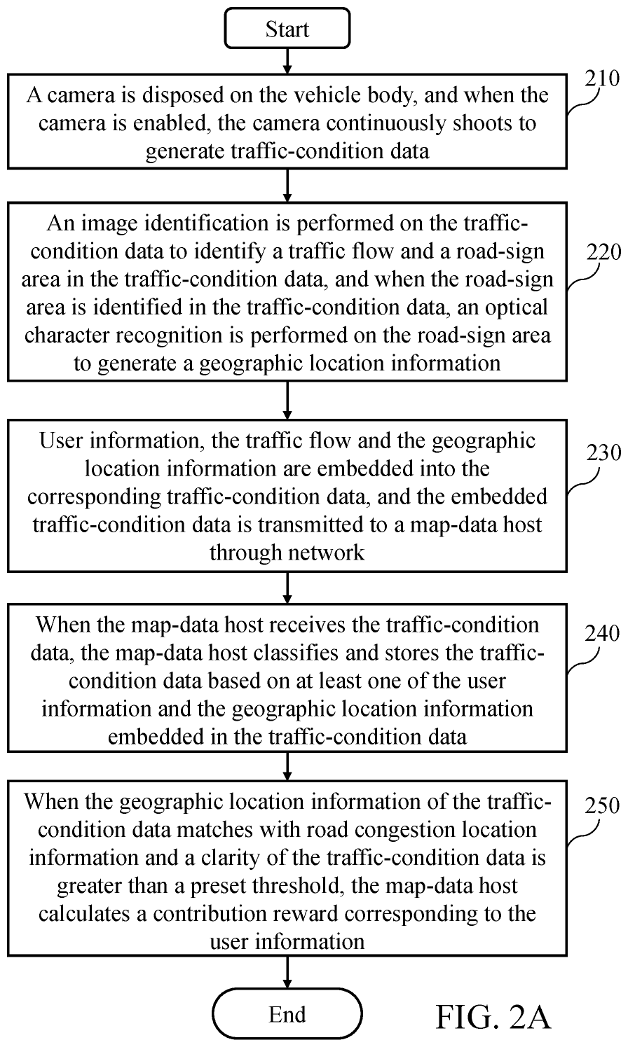

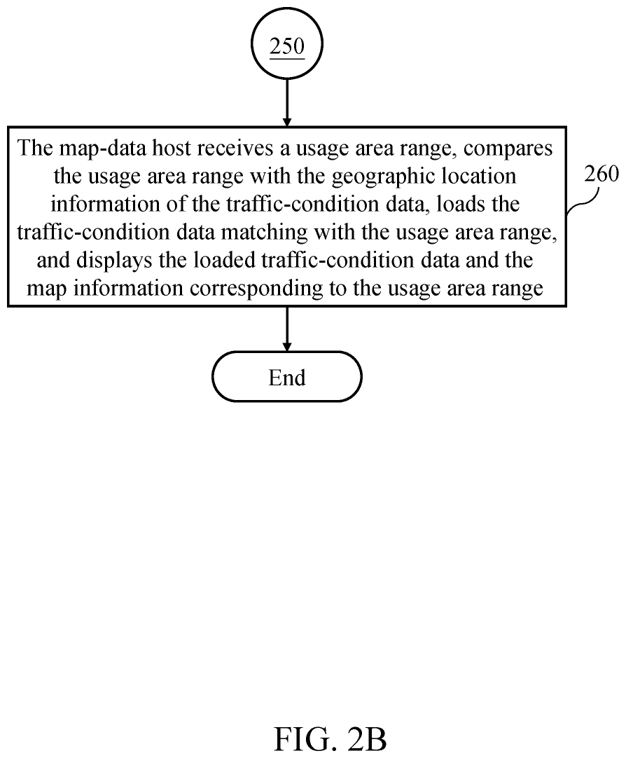

Please refer to FIGS. 2A and 2B, which are flowcharts of a reward method for collecting feedback based on driving records and road conditions, according to the present invention. As shown in FIG. 2A, the reward method can include steps 210 to 250. In the step 210, a camera is disposed on the vehicle body, and when the camera is enabled, the camera continuously shoots to generate traffic-condition data. In a step 220, an image identification is performed on the traffic-condition data to identify a traffic flow and a road-sign area in the traffic-condition data, and when the road-sign area is identified in the traffic-condition data, an optical character recognition is performed on the road-sign area to generate a geographic location information. In a step 230, user information, the traffic flow and the geographic location information are embedded into the corresponding traffic-condition data, and the embedded traffic-condition data is transmitted to a map-data host through network. In a step 240, when the map-data host receives the traffic-condition data, the map-data host classifies and stores the traffic-condition data based on at least one of the user information and the geographic location information embedded in the traffic-condition data. In a step 250, when the geographic location information of the traffic-condition data matches with road congestion location information and a clarity of the traffic-condition data is greater than a preset threshold, the map-data host calculates a contribution reward corresponding to the user information. Through aforementioned steps, the camera disposed on the vehicle body can generate the traffic-condition data, and the traffic flow and the road-sign area in the traffic-condition data is identified, and when presence of the road-sign area is identified, the optical character recognition is performed to generate the geographic location information, so that the user information, the traffic flow and the geographic location information can be embedded into the corresponding traffic-condition data, and the embedded traffic-condition data is transmitted to the map-data host 140 for classification and storage, and when the geographic location information of the traffic-condition data matches with the road congestion location information and the clarity of the traffic-condition data is greater than the preset threshold, the contribution reward corresponding to the user information is calculated.

Furthermore, a step 260 can be executed after the step 250; as shown in FIG. 2B, in the step 260, the map-data host 140 receives a usage area range, compares the usage area range with the geographic location information of the traffic-condition data, loads the traffic-condition data matching with the usage area range, and displays the loaded traffic-condition data and the map information corresponding to the usage area range. In actual implementation, the loaded traffic-condition data and the map information corresponding to the usage area range can be displayed based on the sorting of the shooting time and the current time, for example, when the shooting time is closer to the current time, it indicates that the traffic-condition data is more real time, so the corresponding traffic-condition data is loaded and displayed first contrast, when the time difference between the shooting time and the current time is larger, the traffic-condition data corresponding to the shooting time is loaded and displayed later.

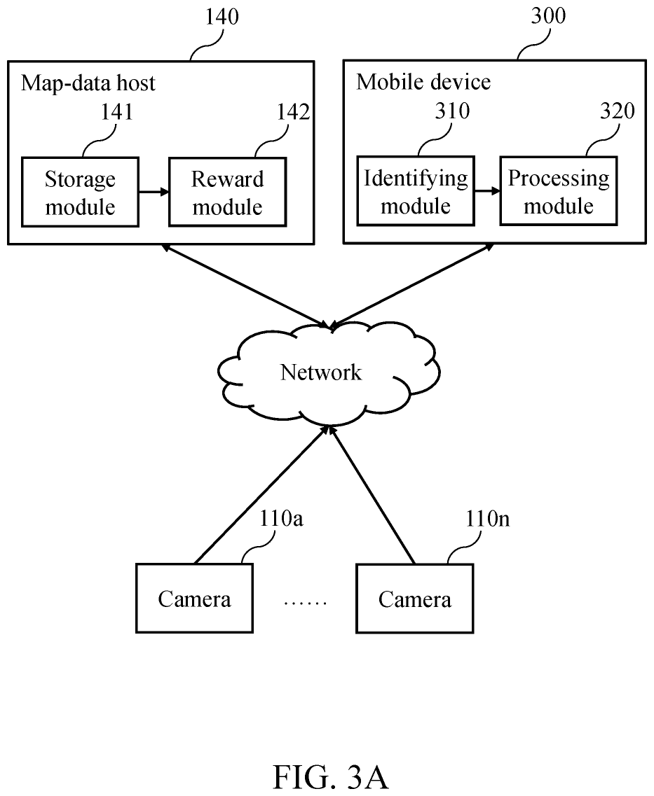

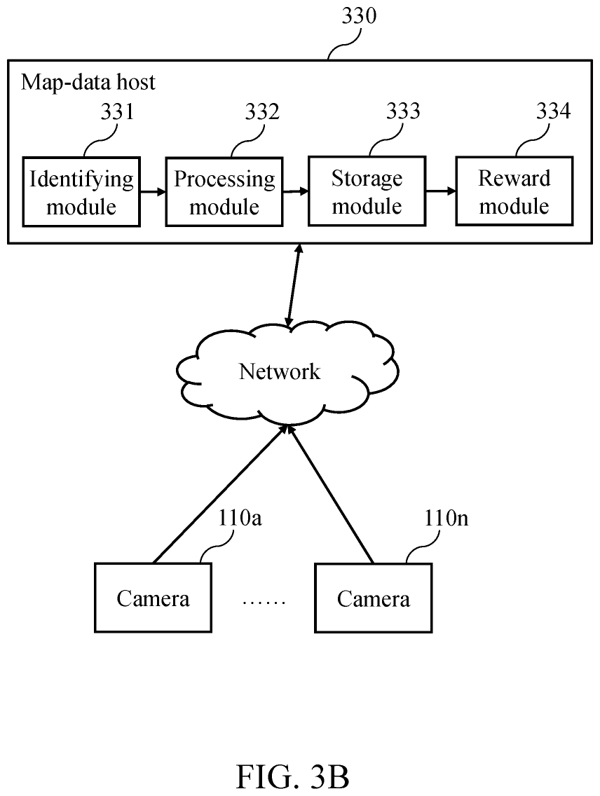

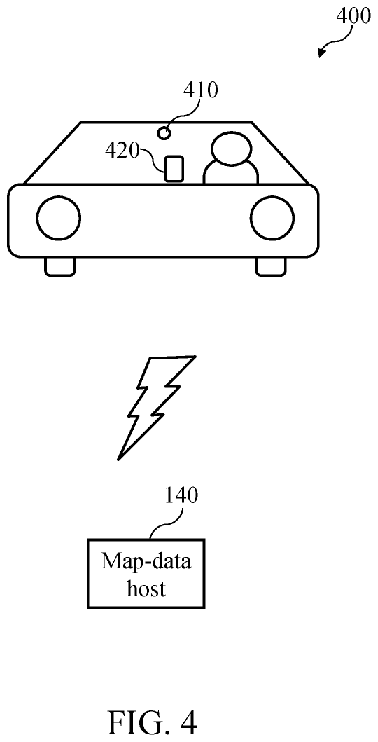

The embodiment of the present invention will be described in the following paragraphs with reference to FIGS. 3A to 4. Please refer to FIG. 3A, which is another system block diagram of a reward system for collecting feedback based on driving records and road conditions, according to the present invention. In actual implementation, cameras (110a-110n) having a network transmission functions are disposed on the vehicle body. Besides the identifying module 120 and the processing module 130 are directly connected to the camera 110 (as shown in FIG. 1), the identifying module 310 and the processing module 320 can be modules of a mobile device 300 (as shown in FIG. 3A), and the mobile device 300 can be, for example, a smartphone, a tablet computer, or a personal digital assistant. After the cameras (110a-110n) generate and transmit the traffic-condition data to the mobile device 300 through the network, the identifying module 310 of the mobile device 300 perform image identification on the received traffic-condition data, to identify the traffic flow and the road-sign area in the traffic-condition data; when the road-sign area is identified, the identifying module 310 performs optical character recognition on the road-sign area to generate the geographic location information, the processing module 320 embeds the user information, the traffic flow, the geographic location information into the corresponding traffic-condition data, and transmits the embedded traffic-condition data to the map-data host 140 for classification and storage, through the network. When the geographic location information of the traffic-condition data matches with the road congestion location information and the clarity of the traffic-condition data is greater than a preset threshold, the map-data host 140 calculates the contribution reward corresponding to the user information.

As shown in FIG. 3B, which is another system block diagram of a reward system for collecting feedback based on driving records and road conditions, according to the present invention. In actual implementation, besides being implemented as shown in FIG. 1 and FIG. 3A, the identifying module and the processing module of the present invention can also be disposed in the map-data host 330; in other words, as shown in FIG. 3B, the map-data host 330 includes an identifying module 331, a processing module 332, a storage module 333, and a. reward module 334. The identifying module 331 is connected to the cameras (110a-110n) through the network, the processing module 332 is connected to the identifying module 331, the storage module 333 is connected to the processing module 332, and the reward module 334 is connected to the storage module 333. The network can be implemented by 5G to improve transmission performance.

As shown in FIG. 4, which is a schematic diagram of generating and transmitting traffic-condition data, according to application of the present invention. In actual implementation, a camera 410 can be disposed on the front part of the vehicle body 400, and when the vehicle body 400 moves, the camera 410 is enabled to take image or video of environment in front of the vehicle body 400 as the traffic-condition data, and transmit the traffic-condition data to the mobile device 420 for identification and processing, through wireless network. The mobile device 420 receives the traffic-condition data from the camera 410, and performs the image identification on the received traffic-condition data, so as to identify the traffic flow and the road-sign area in the traffic-condition data, and when the presence of the road-sign area is identified, the mobile device 420 performs optical character recognition on the road-sign area to generate the geographic location information, for example, when the text in the road-sign area is “third section of Bade road”, the geographic location information records “third section of Bade road” in text. Next, the user information (such as member account, user unique identifier, and so on), the traffic flow, and the geographic location information are embedded into the corresponding traffic-condition data, and the embedded traffic-condition data is transmitted to the map-data host 140 through the network of the mobile device 420, for example, the network of the mobile device 420 can be General Packet Radio Service (GPRS), 3rd-Generation (3G), 4th-Generation (4G), or other like technique. The map-data host 140 classifies and stores the traffic-condition data. When the geographic location information matches with the road congestion location information and the clarity of the traffic-condition data is greater than the preset threshold, the map-data host 140 calculates the contribution reward for the traffic-condition data. For example, the operation of determining the clarity is taken as example, fast Fourier transform can be performed on the image or video, and clarity can be determined based on the low-frequency distribution and high-frequency distribution of the fast Fourier transform result, for example, in a condition that only low amount of high frequency distribution exist, the image or video is determined to be blur, and in contrast, the image or video is determined to be clear; or Laplace transform can be used to perform edge detection, and when the image or video has fewer edges (such as lower than a preset threshold), the image or video is determined to be blur; in contrast, the image or video is determined to be clear. Besides using the mobile device 420 to perform transmission, recognition and data processing, the trip computer with IoV function can replace the mobile device 420, and the trip computer can transmit the traffic-condition data through IoV, and the processor of the trip computer can perform recognition and data processing.

According to above-mentioned contents, the difference between the present invention and the conventional technology is that, in the reward system of the present invention, the camera disposed on a vehicle body can generate traffic-condition data, and image identification is performed on the traffic flow and the road-sign area in the traffic-condition data, and when the road-sign area is identified, the optical character recognition is performed on the road-sign area to generate the geographic location information, and the user information, the traffic flow and the geographic location information are embedded into the corresponding traffic-condition data, and the embedded traffic-condition data is transmitted to the map-data host for classification and storage; when the geographic location information of the traffic-condition data matches with road congestion location information and the clarity of the traffic-condition data is greater than the preset threshold, the contribution reward corresponding to the user information is calculated. Therefore, the technical solution of the present invention is able to solve the conventional technology problem and achieve the technical effect of improving update timeliness of the traffic-condition data and the user's incentive for providing traffic-condition data.

The present invention disclosed herein has been described by means of specific embodiments. However, numerous modifications, variations and enhancements can be made thereto by those skilled in the art without departing from the spirit and scope of the disclosure set firth in the claims.

What is claimed is:

1. A reward system for collecting feedback based on driving records and road conditions, comprising:
at least one camera disposed on a vehicle body, wherein when the at least one camera is enabled, the at least one camera continuously shoots to generate and transmit traffic-condition data;
an identifying module connected to the at least one camera and configured to receive the traffic-condition data from the at least one camera, and perform image identification on the received traffic-condition data to identify a traffic flow and a road-sign area in the traffic-condition data, wherein when identifying that the road-sign area exists in the traffic-condition data, the identifying module performs an optical character recognition on the road-sign area to generate a geographic location information;
a processing module connected to the identifying module and configured to embed user information, the traffic flow and the geographic location information into the corresponding traffic-condition data, and transmit the embedded traffic-condition data through network; and
a map-data host comprising:
a storage module configured to classify and store the traffic-condition data based on at least one of the user information and the geographic location information embedded in the traffic-condition data, when receiving the traffic-condition data; and
a reward module connected to the storage module and configured to calculate a. contribution reward corresponding to the user information when the geographic location information of the traffic-condition data matches with road congestion location information and a clarity of the traffic-condition data is greater than a preset threshold.

2. The reward system for collecting feedback based on driving records and road conditions according to claim 1, wherein the map-data host adjusts the contribution reward corresponding to the user information based on at least one of a size of the traffic flow, repeat times of the geographic location information, and times of loading the traffic-condition data.

3. The reward system for collecting feedback based on driving records and road conditions according to claim 1, wherein the map-data host receives a usage area range and compares the usage area range with the geographic location information of the traffic-condition data, and loads the traffic-condition data matching with the usage area range, and displays the loaded traffic-condition data and map information corresponding to the usage area range,

4. The reward system for collecting feedback based on driving records and road conditions according to claim 1, wherein the map-data host is permitted to receive the road congestion location information from network and permitted to input the traffic-condition data into a road congestion recognition model which is built based on neural network and trained completely, and when the road congestion recognition model recognizes that a road congestion exists in the traffic-condition data, the geographic location information of the traffic-condition data is used as the road congestion location information.

5. The reward system for collecting feedback based on driving records and road conditions according to claim 1, wherein the camera, the identifying module, and the processing module are disposed in a mobile device, or the identifying module and the processing module are disposed in the mobile device and the mobile device is permitted to interconnect with the camera and the map-data host to transmit the traffic-condition data through network, or the identifying module and the processing module are disposed in the map-data host.

6. A reward method for collecting feedback based on driving records and road conditions, comprising:
disposing at least one camera on the vehicle body, wherein when the camera is enabled, the camera continuously shoots to generate traffic-condition data;
performing image identification on the traffic-condition data to identify a traffic flow and a road-sign area in the traffic-condition data, and when the road-sign area is identified in the traffic-condition data, performing an optical character recognition on the road-sign area to generate a geographic location information;
embedding user information, the traffic flow and the geographic location information into the corresponding traffic-condition data, and transmitting the embedded traffic-condition data to a map-data host through network;
when the map-data host receives the traffic-condition data, classifying and storing the traffic-condition data based on at least one of the user information and the geographic location information embedded in the traffic-condition data; and
when the geographic location information of the traffic-condition data matches with road congestion location information and a clarity of the traffic-condition data is greater than a preset threshold, using the map-data host to calculate a contribution reward corresponding to the user information.

7. The reward method for collecting feedback based on driving records and road conditions according to claim 6, wherein the map-data host adjusts the contribution reward corresponding to the user information based on at least one of a size of the traffic flow, repeat times of the geographic location information, and times of loading the traffic-condition data.

8. The reward method for collecting feedback based on driving records and road conditions according to claim 6, further comprising:
receiving, by the map-data host, a usage area range;
comparing the usage area range with the geographic location information of the traffic-condition data;
loading the traffic-condition data matching with the usage area range; and
displaying the loaded traffic-condition data and map information corresponding to the usage area range.

9. The reward method for collecting feedback based on driving records and road conditions according to claim 6, further comprising:
permitting the map-data host to receive the road congestion location information from network and input the traffic-condition data into a road congestion recognition model which is built based on neural network and trained completely; and
when the road congestion recognition model recognizes that a road congestion exists in the traffic-condition data, using the geographic location information of the traffic-condition data as the road congestion location information.

10. The reward method for collecting feedback based on driving records and road conditions according to claim 6, wherein the traffic-condition data comprises a shooting time, the map-data host classifies and stores the traffic-condition data based on the shooting time, and adjusts an order of loading and displaying the traffic-condition data based on a difference between the shooting time and current time.
